(19) United States
(12) Patent Application Publication
(10) Pub. No.: US 2025/0135738 A1
(43) Pub. Date: May 1, 2025

(54) VEHICLE WHEEL AND METHOD FOR MANUFACTURING VEHICLE WHEEL

(71) Applicant: Wonderland Switzerland AG, Steinhausen (CH)

(72) Inventors: Xuemin GUO, Dongguan (CN); Jianhua XIAO, Dongguan (CN)

(73) Assignee: Wonderland Switzerland AG, Steinhausen (CH)

(21) Appl. No.: 18/932,077

(22) Filed: Oct. 30, 2024

(30) Foreign Application Priority Data
Nov. 1, 2023 (CN) 202311447819.8
Nov. 1, 2023 (CN) 202311448311.X
Oct. 25, 2024 (CN) 202411506713.5

(51) Int. Cl. B29D 30/02; B60B 21/02; B60C 7/00; B60C 7/10

(52) U.S. Cl. CPC B29D 30/02; B60B 21/02; B60C 7/102; B29K 2995/0063; B60C 2007/005

(57) ABSTRACT

The present disclosure relates to a vehicle wheel and a method for manufacturing a vehicle wheel. The method includes: forming a tire casing by curing and molding a first material, where the tire casing has a receiving groove; forming an inner tube by centrifugally injecting a second material into the receiving groove and curing and molding the second material; and removing the tire casing and the inner tube as a whole. At least during a process of forming the inner tube by curing, negative-pressure air exhaust is performed.

### CROSS-REFERENCE TO RELATED APPLICATIONS

This application claims priority to Chinese patent application No. 202311448311X, filed on Nov. 1, 2023, Chinese patent application No. 2023114478198, filed on Nov. 1, 2023, and Chinese patent application No. 2024115067135, filed on Oct. 25, 2024, the contents of which are incorporated herein by reference in their entireties.

### TECHNICAL FIELD

The present disclosure relates to the technical field of child carriers, and in particular to a vehicle wheel and a method for manufacturing the vehicle wheel.

### BACKGROUND

Child carriers are convenient for parents to take their children out. When vehicle wheels are used to move the child carrier on the road, hands of the parent can be freed. Strollers are a common type of child carrier. At present, tire casings and inner tubes of the vehicle wheels of the conventional child carrier are prone to loosening after being used for a period of time, resulting in reduced stability of the vehicle wheels operation. In addition, the rubber material used for the vehicle wheels is prone to the blooming and contact or migration staining problems, leaving black marks on the ground where the vehicle wheels pass, which gives users a bad user experience.

### SUMMARY

According to various embodiments of the present disclosure, a vehicle wheel, and a method for manufacturing a vehicle wheel are provided. In addition, the present disclosure further provides a child carrier including the vehicle wheel.

According to a first aspect of the present disclosure, a method for manufacturing a vehicle wheel is provided. The method includes: forming a tire casing by curing and molding a first material, where the tire casing has a receiving groove; forming an inner tube by centrifugally injecting a second material into the receiving groove and curing and molding the second material; and removing the tire casing and the inner tube as a whole. At least during a process of forming the inner tube by curing, negative-pressure air exhaust is performed.

In an embodiment, forming the tire casing by curing and molding the first material includes: providing a first mould, where the first mould is provided with a first injection cavity and a first injection hole in communication with the first injection cavity; centrifugally injecting the first material into the first mould through the first injection hole, and enabling the first material to evenly cover an inner wall of the first mould; and obtaining the tire casing by cooling and curing the first material, where the tire casing is retained in the first mould.

In an embodiment, forming the inner tube by curing includes: centrifugally injecting the second material into the first mould through the first injection hole, filling the receiving groove of the tire casing with the second material; and obtaining the inner tube by foaming and curing the second material, where the inner tube and the tire casing are connected as a whole.

In an embodiment, the first mould has a first main channel. The first injection hole extends from a sidewall of the first main channel to an inner wall of the first injection cavity. A plurality of the first injection hole are provided and are evenly distributed in a circumferential direction of the first mould. Or, the first injection hole extends in a circumferential direction of the first mould.

In an embodiment, in the first mould, a portion of a cavity wall of the first injection cavity covered by the first material serves as a first cavity wall, another portion of the cavity wall of the first injection cavity not covered by the first material serves as a second cavity wall. The first injection hole extends through the second cavity wall and is in communication with the first injection cavity. The first mould is provided with a first exhaust hole configured to perform negative-pressure air exhaust. The first exhaust hole extends through the second cavity wall and is in communication with the first injection cavity.

In an embodiment, the negative-pressure air exhaust is performed during a process of centrifugally injecting the first material into the first mould and cooling and curing the first material.

In an embodiment, the first material includes polyurethane, the second material includes polyurethane. A density of the tire casing is greater than a density of the inner tube.

In an embodiment, forming the tire casing by curing and molding the first material includes: providing a tire casing mould; injecting the first material into the tire casing mould by an injection molding machine; obtaining the tire casing by cooling and curing the first material; and removing the tire casing from the tire casing mould.

In an embodiment, forming the inner tube by curing includes: providing a second mould, where the second mould is provided with a second injection cavity and a second injection hole in communication with the second injection cavity; placing the tire casing in the second injection cavity, and attaching the tire casing to a cavity wall of the second injection cavity; centrifugally injecting the second material into the second injection cavity through the second injection hole, and filling the receiving groove with the second material; and obtaining the inner tube by foaming and curing the second material, where the inner tube and the tire casing are connected as a whole.

In an embodiment, the second mould has a second main channel. The second injection hole extends from a sidewall of the second main channel to an inner wall of the second injection cavity. A plurality of the second injection holes are provided, and are evenly distributed in a circumferential direction of the second mould. Or, the second injection hole extends in a circumferential direction of the second mould.

In an embodiment, in the second mould, a portion of the cavity wall of the second injection cavity that is in contact with the tire casing serves as a first cavity wall, another portion of the cavity wall of the second injection cavity that is not in contact with the tire casing serves as a second cavity wall. The second injection hole extends through the second cavity wall and is in communication with the second injection cavity.

The second mould is provided with a second exhaust hole configured to perform negative-pressure air exhaust. The second exhaust hole extends through the second cavity wall and is in communication with the second injection cavity.

In an embodiment, the first material includes thermoplastic polyurethane, and the second material includes polyurethane.

In an embodiment, the method further includes: sleeving the tire casing and the inner tube as a whole on a hub.

According to a second aspect of the present disclosure, a method for manufacturing a vehicle wheel is provided. The method includes: forming an inner tube by curing and molding a second material; providing a first mould, where the first mould is provided with a first injection cavity, a first injection hole in communication with the first injection cavity, and a plurality of positioning pins capable of being partially inserted into the first injection cavity; fixing the inner tube in the first injection cavity by the plurality of positioning pins, and forming a tire casing injection cavity between an inner wall of the first injection cavity and the inner tube; injecting a first material into the tire casing injection cavity through the first injection hole and curing the first material; completely removing the plurality of positioning pins from the first injection cavity when the first material is not completely cured and molded, and enabling the first material to enter a space where the plurality of positioning pins are removed; and obtaining a tire casing by completely curing and molding the first material, where the tire casing covers the inner tube.

In an embodiment, the inner tube is provided with a plurality of positioning holes; and the inner tube is fixed in the first injection cavity by inserting the plurality of positioning pins into the plurality of positioning holes, respectively.

In an embodiment, completely removing the plurality of positioning pins from the first injection cavity includes: removing the plurality of positioning pins until ends of the plurality of positioning pins are coplanar with an inner wall of the first injection cavity.

In an embodiment, in forming the inner tube by curing and molding the second material, the inner tube has an outer annular surface provided with a pattern.

In an embodiment, the second material includes ethylene-vinyl acetate copolymer, and the first material includes polyurethane.

According to a third aspect of the present disclosure, a vehicle wheel is provided. The vehicle wheel includes: a tire casing made of the first material, the tire having a receiving groove, and an inner wall of the receiving groove being arc-shaped; and an inner tube made of a second material, and the inner tube including a main body received in the receiving groove and a protrusion protruding from the receiving groove. The main body has an outer annular surface that is arc-shaped. The outer annular surface is attached to the inner wall of the receiving groove.

In an embodiment, the vehicle wheel further includes: a hub provided with an annular mounting groove. The inner tube and the tire casing are connected as a whole and are sleeved on the hub. The protrusion of the inner tube is engaged in the mounting groove.

In an embodiment, a first step surface is formed on a side of the main body connected to the protrusion, and an end of a groove wall of the mounting groove abuts against the first step surface.

In an embodiment, a density of the tire casing is in a range of 0.6 g/cm³ to 0.8 g/cm³, and a density of the inner tube is in a range of 0.2 g/cm³ to 0.6 g/cm³.

In an embodiment, the first material includes polyurethane, the second material includes polyurethane. A density of the tire casing is greater than a density of the inner tube.

According to a fourth aspect of the present disclosure, a vehicle wheel is provided. The vehicle wheel includes a hub, an inner tube and a tire casing. The hub has an annular shape. The hub is provided with a mounting groove extending in a circumferential direction thereof. An inner tube is sleeved on the hub and at least partially received in the mounting groove. The tire casing covers the inner tube. An inner surface of the tire casing is in contact with the inner tube. One of an outer surface of the tire casing and the hub is provided with a first concave portion, and another one of the outer surface of the tire casing and the hub is provided with a first convex portion engaged with the first concave portion. One of the inner surface of the tire casing and the inner tube is provided with a second convex portion, and another one of the inner surface of the tire casing and the inner tube is provided with a second concave portion, and where the second convex portion and the second concave portion are engaged with each other and located in the mounting groove.

In an embodiment, the tire casing includes a first ring portion and two second ring portions disposed at two ends of the first ring portion. The first ring portion is located outside the mounting groove. Outer surfaces of the two second ring portions respectively presses against a sidewall of the mounting groove. The second convex portion is disposed on each of inner surfaces of the two second ring portions, and the second concave portion is disposed on the inner tube.

In an embodiment, at least a portion of the inner tube extends out of the tire casing and forms an inner annular surface. The inner annular surface presses against a bottom wall of the mounting groove.

According to a fifth aspect of the present disclosure, a vehicle wheel is provided. The vehicle wheel incudes: an inner tube made of a first material; and a tire casing made of a second material. The first material includes thermoplastic polyurethane material, and the second material includes ethylene-vinyl acetate copolymer material.

In an embodiment, the vehicle wheel further includes: a hub having an annular shape. The hub is provided with a mounting groove extending in a circumferential direction thereof. The inner tube is sleeved on the hub and at least partially received in the mounting groove. The tire casing covers the inner tube. An inner surface of the tire casing presses against the inner tube. One of an outer surface of the tire casing and the hub is provided with a first concave portion, and another one of the outer surface of the tire casing and the hub is provided with a first convex portion. The first convex portion is engaged with the first concave portion. One of the inner surface of the tire casing and the inner tube is provided with a second convex portion, and another one of the inner surface of the tire casing and the inner tube is provided with a second concave portion. The second convex portion and the second concave portion are engaged with each other and located in the mounting groove.

In an embodiment, the first convex portion is disposed at an opening of the mounting groove. The first concave portion is disposed on the outer surface of the tire casing.

In an embodiment, the tire casing includes a first ring portion and two second ring portions disposed at two ends of the first ring portion. The first ring portion is located outside the mounting groove. Outer surfaces of the two second ring portions respectively presses against a sidewall of the mounting groove. The second convex portion is disposed on each of inner surfaces of the two second ring portions, and the second concave portion is disposed on the inner tube.

In an embodiment, the hub includes a thorn provided on the mounting groove thereof. The inner tube has an inner annular surface capable of pressing against a bottom wall of the mounting groove. The thorn extends through the inner annular surface and is embedded in the inner tube.

In an embodiment, at least one of the inner surface of the tire casing and an outer surface of the inner tube is provided with a cross pattern.

In an embodiment, at least a portion of the inner tube extends out of the tire casing and forms an inner annular surface. The inner annular surface is capable of pressing against a bottom wall of the mounting groove.

In an embodiment, a density of the tire casing is greater than a density of the inner tube.

In the sixth aspect of the present disclosure, a method for manufacturing a vehicle wheel according to the fifth aspect includes: obtaining the tire casing by injecting the first material into a third mould through injection molding, and curing the first material; obtaining the inner tube by foaming and curing the second material in a fourth mould; and sleeving the tire casing outside the inner tube, and pressing an inner surface of the tire casing against the inner tube under an elasticity of the tire casing, and connecting the tire casing and the inner tube as a whole.

According to a seventh aspect of the present disclosure, a child carrier is provided, including the vehicle wheel according to any one of the embodiments of the third aspect and the fourth aspect.

### BRIEF DESCRIPTION OF THE DRAWINGS

In order to illustrate the embodiments of the present disclosure more clearly, the drawings used in the embodiments will be described briefly. Apparently, the following described drawings are merely for the embodiments of the present disclosure, and other drawings can be derived by those of ordinary skill in the art without any creative effort.

FIG. 1 is a perspective view showing a vehicle wheel according to a first embodiment of the present disclosure.

FIG. 2 is an exploded view of the vehicle wheel of FIG. 1.

FIG. 3 is a cross-sectional view taken along a line U1-U1 of FIG. 1.

FIG. 4 is a schematic view showing a process of manufacturing the vehicle wheel according to the first embodiment of the present disclosure, which is in the stage of centrifugal injection of a first material.

FIG. 5 is a schematic view showing a process of manufacturing the vehicle wheel according to the first embodiment of the present disclosure, which is in the stage of centrifugal injection of a second material.

FIG. 6 is a schematic view showing a process of manufacturing the vehicle wheel according to the first embodiment of the present disclosure, which is in the stage of foaming and curing the second material.

FIG. 7 is a perspective view of a first mould according to some embodiments of the present disclosure, where the first mould is used to manufacture the vehicle wheel according to the first embodiment of the present disclosure.

FIG. 8 is a perspective view of a first mould according to some other embodiments of the present disclosure, where the first mould is used to manufacture the vehicle wheel according to the first embodiment of the present disclosure.

FIG. 9 is a perspective view showing a vehicle wheel according to a second embodiment of the present disclosure.

FIG. 10 is an exploded view of the vehicle wheel of FIG. 9.

FIG. 11 a cross-sectional view taken along a line U2-U2 of FIG. 9.

FIG. 12 is a schematic view showing a process of manufacturing the vehicle wheel according to the second embodiment of the present disclosure.

FIG. 13 is a perspective view of a second mould according to some embodiments of the present disclosure, where the second mould is used to manufacture the vehicle wheel according to the second embodiment of the present disclosure.

FIG. 14 is a flowchart of a method for manufacturing a vehicle wheel according to some embodiments of the present disclosure.

FIG. 15 is a top view of a third mould used for forming a tire casing of a vehicle wheel by curing.

FIG. 16 is a flowchart of a method for manufacturing the vehicle wheel according to some embodiments of the present disclosure.

FIG. 17 is a perspective view showing a vehicle wheel according to a third embodiment of the present disclosure.

FIG. 18 is an exploded view of the vehicle wheel according to the third embodiment of the present disclosure.

FIG. 19 is a cross-sectional view taken along a line U3-U3 of FIG. 17.

FIG. 20 is a schematic view showing a process of manufacturing the vehicle wheel according to the third embodiment of the present disclosure.

FIG. 21 is a flowchart of a method for manufacturing a vehicle wheel according to the third embodiment of the present disclosure.

FIG. 22 is a flowchart of step S1 of the method for manufacturing the vehicle wheel according to the first embodiment of the present disclosure.

FIG. 23 is a flowchart of step S2 of the method for manufacturing the vehicle wheel according to the first embodiment of the present disclosure.

FIG. 24 is a flowchart of step S1 of the method for manufacturing the vehicle wheel according to the second embodiment of the present disclosure.

FIG. 25 is a flowchart of step S2 of the method for manufacturing the vehicle wheel according to the second embodiment of the present disclosure.

### DETAILED DESCRIPTION

In order to make the above-mentioned objects, features and advantages of the present disclosure more obvious and easy to understand, the specific implementations of the present disclosure are described in detail below in conjunction with the accompanying drawings. In the following description, many specific details are set forth to facilitate a full understanding of the present disclosure. However, the present disclosure can be implemented in many other ways different from those described herein, and those skilled in the art can make similar improvements without violating the connotation of the present disclosure, so the present disclosure is not limited by the specific embodiments disclosed below.

In the description of the present disclosure, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise” “counterclockwise”, “axial”, “radial”, “circumferential” and the like indicate orientations or positional relationships based on the orientations or positional relationships shown in the accompanying drawings, and are only for the convenience of describing the present disclosure and simplifying the description, and do not indicate or imply that the indicated device or element must have a specific orientation, be constructed and operated in a specific orientation, and therefore should not be understood as a limitation on the present disclosure.

In addition, the terms “first” and “second” are used for descriptive purposes only and should not be understood as indicating or implying relative importance or implicitly indicating the number of the indicated technical features. Therefore, the features defined by “first” and “second” may explicitly or implicitly include at least one of the features. In the description of this application, the “plurality” means at least two, such as two, three, etc., unless otherwise clearly and specifically defined.

In this application, unless otherwise clearly specified and limited, the terms “mounting”, “coupling”, “connection”, “fixation” and the like should be understood in a broad sense, for example, which can be a fixed connection, a detachable connection, or an integral connection; or can be a mechanical connection or an electrical connection; or can be a direct connection or an indirect connection through an intermediate medium; or can be the internal connection of two elements or the interaction relationship between two elements, unless otherwise clearly defined. For ordinary skills in this field, the specific meanings of the above terms in the present disclosure can be understood according to specific circumstances.

In the present disclosure, unless otherwise clearly specified and limited, a first feature being “above” or “below” a second feature may mean that the first and second features are in direct contact, or the first and second features are in indirect contact through an intermediate medium. Moreover, a first feature being “over”, “above”, and “on top of” a second feature may mean that the first feature is directly above or obliquely above the second feature, or simply means that the first feature is higher in level than the second feature. A first feature being “under”, “below”, and “underneath” a second feature may mean that the first feature is directly below or obliquely below the second feature, or simply means that the first feature is lower in level than the second feature.

It should be noted that when an element is referred to as being “fixed to” or “disposed on” another element, it may be directly on the other element or there may be an intermediate element. When an element is considered to be “connected to” another element, it may be directly connected to the other element or there may be an intermediate element at the same time. The terms “vertical”, “horizontal”, “upper”, “lower”, “left”, “right” and similar expressions used herein are for illustrative purposes only and do not represent the unique implementation.

The present disclosure provides a vehicle wheel 100 and a child carrier having the vehicle wheel 100.

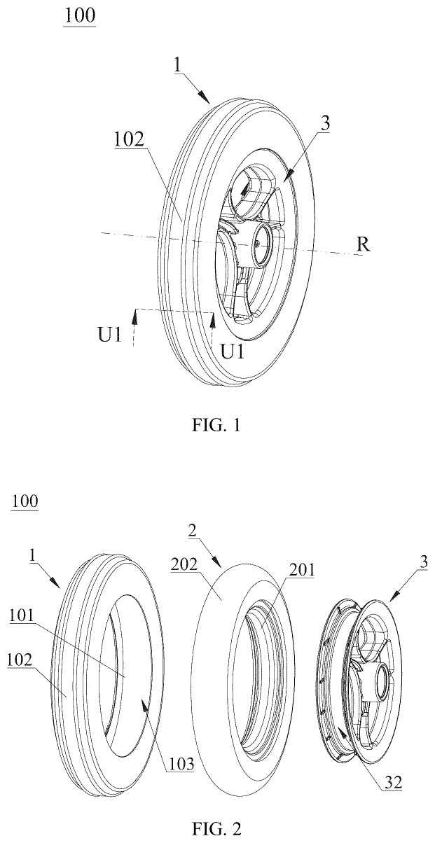

FIG. 1 is a perspective view of a vehicle wheel 100 according to a first embodiment of the present disclosure, and FIG. 2 is an exploded view of the vehicle wheel 100 of FIG. 1.

As shown in FIGS. 1 and 2, the vehicle wheel 100 includes a hub 3, a tire casing 1 and an inner tube 2. The hub 3 is provided with an annular mounting groove 32. The tire casing 1 and the inner tube 2 are sleeved on the hub 3 and at least partially engaged in the mounting groove 32. The tire casing 1 is made of a first material, and the density of the tire casing 1 is, for example, in a range of 0.6 g/cm³ to 0.8 g/cm³. The inner tube 2 is made of a second material, and the density of the inner tube 2 is, for example, in a range of 0.2 g/cm³ to 0.6 g/cm³. The first material includes, for example, polyurethane (PU), and the second material includes, for example, polyurethane (PU). The density of the tire casing 1 made of the first material is greater than the density of the inner tube 2 made of the second material. In this embodiment, the density of the tire casing 1 is relatively high, so that the tire casing 1 has good wear resistance. The density of the inner tube 2 is less than that of the tire casing 1. Compared with the related art where the densities of the inner tube 2 and the tire casing 1 are both high, the inner tube 2 with a lower density can result in a lower overall cost and weight of the vehicle wheel 100, as well as increased elasticity of the vehicle wheel 100.

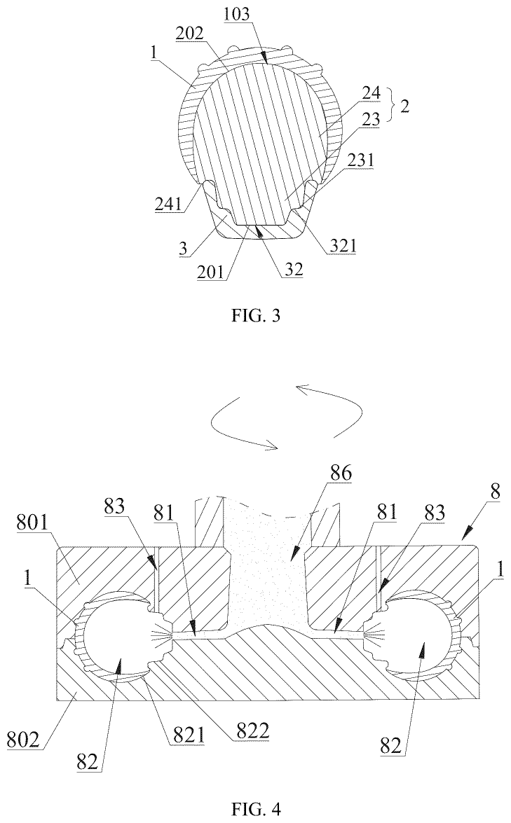

Referring to FIG. 3, the tire casing 1 has a receiving groove 103, and the inner wall of the receiving groove 103 is arc-shaped. The inner tube 2 includes a main body 24 received in the receiving groove 103 and a protrusion 23 protruding from the receiving groove 103. The main body 24 has an outer annular surface 202. The outer annular surface 202 is arc-shaped. The outer annular surface 202 is attached to the inner wall of the receiving groove 103. In this embodiment, since the first material used to manufacture the tire casing 1 and the second material used to manufacture the inner tube 2 both include polyurethane materials, and thus can be well fused together. In this way, the tire casing 1 and the inner tube 2 can be in close contact with each other. Specifically, the outer annular surface 202 of the inner tube 2 can be connected to the inner wall of the receiving groove 103 of the tire casing 1 as a whole, thereby enhancing the connection strength between the tire casing 1 and the inner tube 2, and preventing the inner tube 2 from being loosened or separated from the tire casing 1 during the use of the vehicle wheel 100. The protrusion 23 is configured to be connected to the hub 3, and specifically, the protrusion 23 is engaged in the mounting groove 32. More specifically, the protrusion 23 of the inner tube 2 forms an inner annular surface 201 of the inner tube 2. The inner annular surface 201 is attached to the bottom wall of the mounting groove 32. A first step surface 241 is formed on a side of the main body 24 connected to the protrusion 23. An end of the groove wall of the mounting groove 32 abuts against the first step surface 241. In other words, in this embodiment, only the protrusion 23 of the inner tube 2 is engaged with the mounting groove 32, and the tire casing 1 and the main body 24 of the inner tube 2 are both located outside the mounting groove 32.

Still referring to FIG. 3, the protrusion 23 has a second step surface 231, and a third step surface 321 is provided in the mounting groove 32. The shape of the third step surface 321 matches the shape of the second step surface 231. When the protrusion 23 is engaged in the mounting groove 32, the second step surface 231 abuts against the third step surface 321. In this way, the protrusion 23, i.e., the inner tube 2, can be engaged to the mounting groove 32 more firmly and stably. As shown in FIG. 3, the first step surface 241, the second step surface 231, and the inner annular surface 201 are staggered in a direction parallel to a rotation axis R of the vehicle wheel 100, and are also staggered in a radial direction of the vehicle wheel 100. In other words, the first step surface 241, the second step surface 231, and the inner annular surface 201 are arranged in sequence in a stepped shape. In this way, the pressure bearing area between the inner tube 2 and the hub 3 can be increased, so that when the vehicle wheel 100 is elastically deformed during use, the interaction force between the inner tube 2 and the hub 3 is distributed more widely and evenly, and the whole composed of the tire casing 1 and the inner tube 2 is prevented from being skewed relative to the hub 3 or even separated from the hub 3 after the vehicle wheel 100 is subjected to force. In some embodiments, in order to connect the inner tube 2 and the hub 3 more firmly and stably, the surface of the protrusion 23 may be at least partially coated with an adhesive. Alternatively, the inner wall of the mounting groove 32 may be at least partially coated with an adhesive. Alternatively, both the surface of the protrusion 23 and the inner wall of the mounting groove 32 may be at least partially coated with an adhesive.

According to the vehicle wheel 100 of the first embodiment of the present disclosure, the outer annular surface 202 of the inner tube 2 is tightly attached to the inner wall of the receiving groove 103 of the tire casing 1 as a whole, which can enhance the connection strength between the inner tube 2 and the tire casing 1 and prevent the inner tube 2 from being loosened or separated from the tire casing 1.

The present disclosure further provides a method for manufacturing the vehicle wheel 100 in the first embodiment.

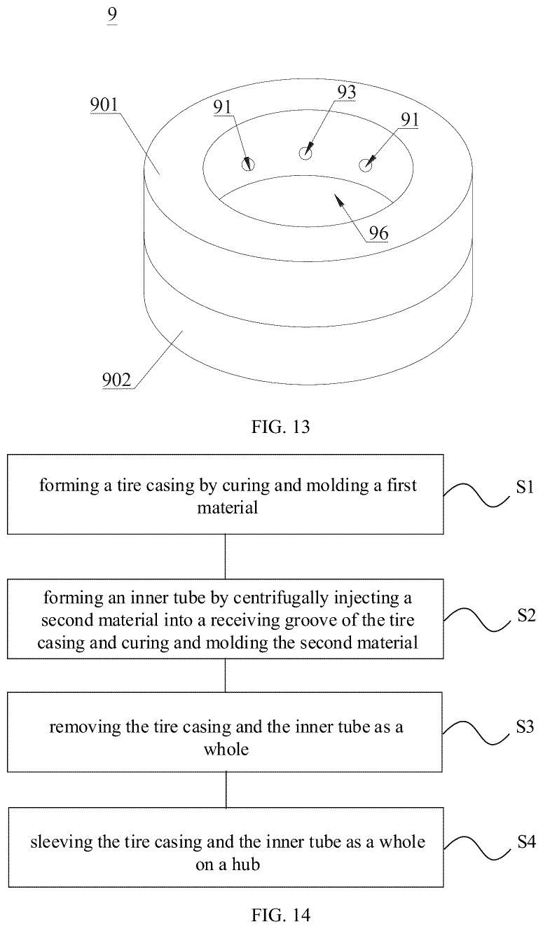

FIG. 14 is a flowchart of a method for manufacturing the vehicle wheel 100 according to some embodiments of the present disclosure. As shown in FIG. 14, the method for manufacturing the vehicle wheel 100 according to the first embodiment of the present disclosure includes the following steps S1 to S3.

At S1, a first material is cured and molded to form a tire casing 1.

Referring to FIGS. 2 and 3, the tire casing 1 has a receiving groove 103. The step S1 of curing and molding the first material to form the tire casing 1 specifically includes the following steps S11 to S13 (see FIG. 22).

At S11, a first mould 8 is provided.

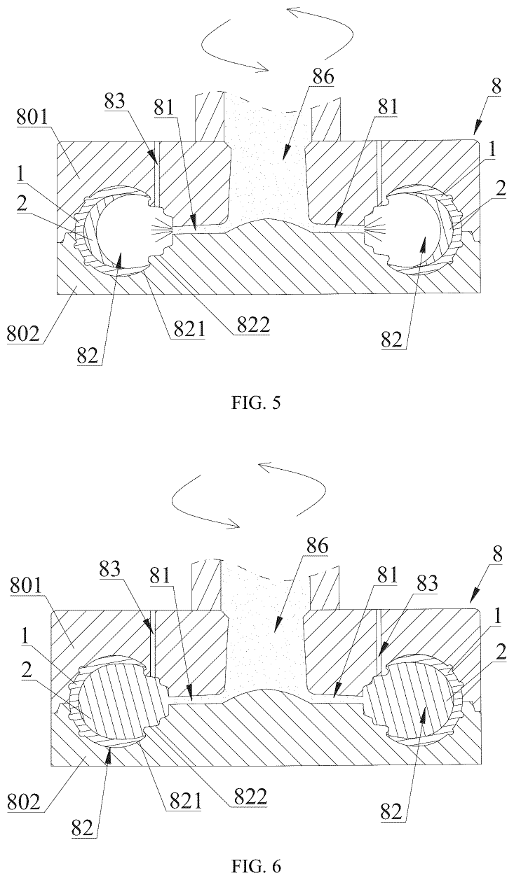

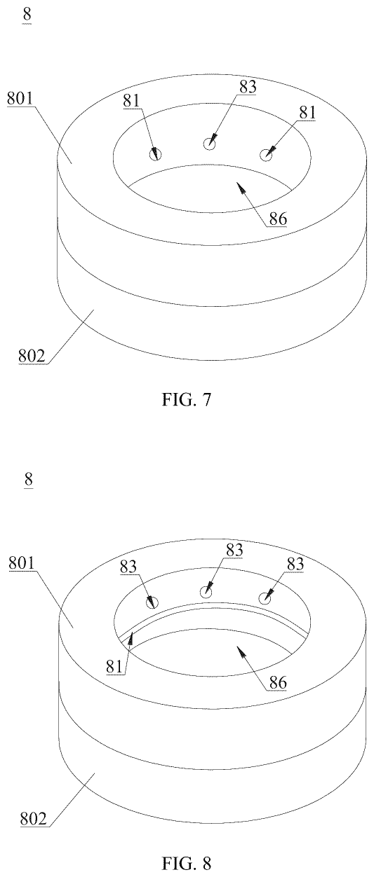

Referring to FIGS. 4 to 6, the first mould 8 is provided with a first injection cavity 82 and a first injection hole 81 in communication with the first injection cavity 82. The first mould 8 is further provided with a first main channel 86. The first main channel 86 is in communication with the first injection hole 81. The first main channel 86 extends substantially parallel to the central axis of the first mould 8. In other words, the first main channel 86 extends substantially in the longitudinal direction, or extends in a direction parallel to the rotation axis R of the vehicle wheel 100. The first main channel 86 is configured to connect an injection device or a pipeline. Specifically, the first mould 8 includes a first upper mould 801 and a first lower mould 802. The first upper mould 801 and the first lower mould 802 are detachably connected to each other, and jointly form the first injection cavity 82. The first injection hole 81 extends through the sidewall of the first main channel 86 to the inner wall of the first injection cavity 82. Specifically, the first injection hole 81 extends substantially in the radial direction of the vehicle wheel and is in communication with the first main channel 86 and the first injection cavity 82, respectively. The first injection hole 81 can be provided on the first upper mould 801, or on the first lower mould 802, or on the connection between the first upper mould 801 and the first lower mould 802, and which is not limited thereto. In some embodiments, as shown in FIG. 7, a plurality of, such as four, five, six, etc., first injection holes 81 are provided and evenly distributed in the circumferential direction of the first mould 8. In other embodiments, as shown in FIG. 8, only one first injection hole 81 is provided. Such first injection hole 81 extends in the circumferential direction of the first mould 8. That is, a projection of the first injection hole 81 on a plane parallel to the circumferential direction of the first mould 8 is annular. The first injection hole 81 is in communication with the first injection cavity 82.

At S12, a first material is centrifugally injected into the first mould 8 through the first injection holes 81, so that the first material evenly covers the inner wall of the first mould 8. The first material includes PU, for example.

As shown in FIGS. 4 to 6, in the first mould 8, a portion of the cavity wall of the first injection cavity 82 covered by the first material serves as a first cavity wall 821, and another portion of the cavity wall of the first injection cavity 82 not covered by the first material serves as a second cavity wall 822. The first injection hole 81 extends through the second cavity wall 822 and is in communication with the first injection cavity 82. The first mould 8 is provided with a first exhaust hole 83 for negative-pressure air exhaust. The first exhaust hole 83 extends the second cavity wall 822 and is in communication with the first injection cavity 82. A plurality of first exhaust holes 83 are provided. Negative-pressure air exhaust may be performed in the first injection cavity 82 through these first exhaust holes 83. The plurality of first exhaust holes 83 are disposed on the first mould 8 at positions corresponding to the protrusion 23 of the inner tube 2, that is, an opening end of the first exhaust hole 83 is located on the second cavity wall 822. In this way, the cross-section of the inner tube 2 of the vehicle wheel 100 formed by cutting off the excess portions formed in the plurality of first exhaust holes 83 can be hidden in the mounting groove 32 of the hub 3, making the vehicle wheel 100 more aesthetic.

In some embodiments, as shown in FIGS. 4 to 6, the first exhaust holes 83 may extend in a substantially longitudinal direction, i.e., a direction parallel to the rotation axis R of the vehicle wheel 100. For example, the first exhaust holes 83 extend from the upper surface of the first mould 8 to the inner wall of the first injection cavity 82. In other embodiments, the first exhaust hole 83 may also extend in a substantially transverse direction, i.e., a direction parallel to the radial direction of the vehicle wheel 100. For example, the first exhaust holes 83 extend from the inner wall of the first main channel 86 to the second cavity wall 822. Specifically, referring to FIG. 8, the plurality of first exhaust holes 83 may be distributed above or below the first injection holes 81 in the longitudinal direction. Referring to FIG. 7, the plurality of first exhaust holes 83 may also be located on the same transverse plane as the plurality of first injection holes 81, and the plurality of first exhaust holes 83 and the plurality of first injection holes 81 may be alternately spaced apart from each other in the circumferential direction, which is not limited herein.

It should be noted that centrifugal injection refers to centrifugally rotating a mould when the material is injected into the mould. Specifically, as shown in FIGS. 4 to 7, the first material (such as PU) is injected into the first injection cavity 82 through the plurality of first injection holes 81. During this process, the first mould 8 rotates centrifugally, so that the first material is thrown toward and evenly covers the first cavity wall 821 of the first injection cavity 82 under the action of centrifugal force, then the first material can be cooled and cured to form an arc-shaped inner surface 101, i.e., the bottom wall of the receiving groove 103.

At S13, the first material is cooled and cured, and a tire casing 1 is obtained. The tire casing 1 is retained in the first mould 8. The density of the tire casing 1 is, for example, in a range of 0.6 g/cm³ to 0.8 g/cm³. The wall thickness of the tire casing 1 is, for example, 2.2 mm or above. In some other embodiments, the wall thickness of the tire casing 1 may also be set to other suitable values depending on the use of the vehicle wheel 100 and the weight that the vehicle wheel 100 needs to bear. In this embodiment, it is also necessary to determine the amount of the material required according to the size of the tire casing 1 including the wall thickness, diameter, height, etc., thereby controlling the amount of the first material injected into the first injection cavity 82.

In this embodiment, the cured tire casing 1 has a receiving groove 103. Since the first material is thrown onto the first cavity wall 821 of the first injection cavity 82 by centrifugal rotation, the inner wall of the receiving groove 103 of the tire casing 1 is generally arc-shaped. In addition, the cured tire casing 1 is continued to be retained in the first injection cavity 82 of the first mould 8, so as to inject a second material to form an inner tube 2.

In the above steps S12 and S13, negative-pressure air exhaust is required to be performed through the first exhaust holes 83 to keep the pressure in the first injection cavity 82 less than 0, for example, keep the pressure at about −0.05 Mpa. Compared with the situation where no negative-pressure air exhaust is provided, for example, atmosphere air exhaust through the exhaust holes, negative-pressure air exhaust can help the air to be exhausted, so that the process of injecting the first material is smoother and the forming speed of the tire casing 1 can be speeded up.

By combining negative-pressure air exhaust and centrifugal injection, the material (such as the first material) can be cured and molded better and more evenly, and the density of the resulted product can be improved, so that the parameters of the resulted product (such as the tire casing 1) is closer to the theoretical value. For example, the actual weight of the tire casing 1 has an error range of ±5% to ±10% compared to the theoretical weight.

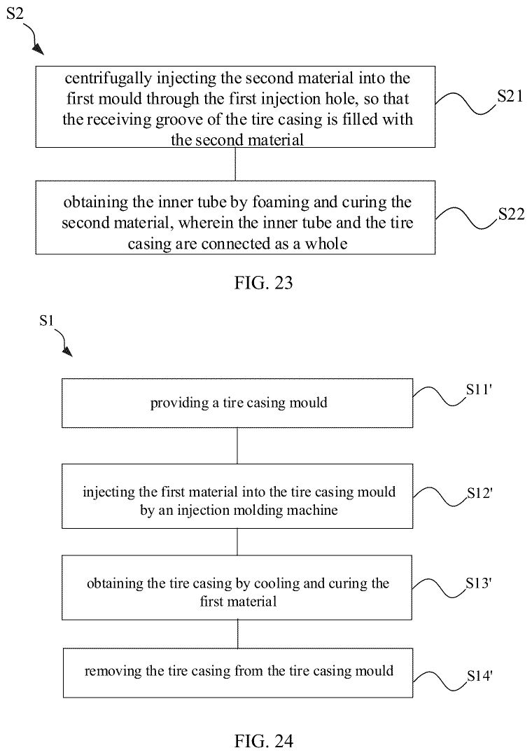

At S2, the second material is centrifugally injected into the receiving groove 103 of the tire casing 1, and is cured and molded to form the inner tube 2. The step of curing and molding the second material to form the inner tube 2 specifically includes the following steps S21 to S22 (see FIG. 23).

At S21, the second material is centrifugally injected into the first mould 8 through the first injection holes 81, so that the receiving groove 103 of the tire casing 1 is filled with the second material. Due to the centrifugal injection, the second material is evenly thrown to and covered on the inner wall of the receiving groove 103 of the tire casing 1 (i.e., the inner surface 101 of the tire casing 1) and the second cavity wall 822 of the first injection cavity 82, so as to fill the space of the first injection cavity 82 that is not filled with the first material. In this embodiment, the second material includes PU, for example. The amount of the second material to be injected can be determined according to the size of the inner tube 2 to be obtained. Since the first material and the second material both include polyurethane materials, when the second material covers the inner wall of the receiving groove 103 of the tire casing 1 (i.e., the inner surface 101 of the tire casing 1), the second material and the inner wall of the receiving groove 103 can be well fused together, so that the tire casing 1 and the inner tube 2 can be in close contact with each other, as such, the inner tube 2 and the tire casing 1 can be prevented from being loosened or separated from each other during the use of the vehicle wheel 100.

At S22, the second material is foamed and cured to form the inner tube 2. The density of the inner tube 2 is in a range of about 0.2 g/cm³ to 0.6 g/cm³. The density of the inner tube 2 is less than that of the tire casing 1. Specifically, the foaming time of the second material is in a range of about 3 minutes to 4 minutes. It should be noted that, for inner tubes 2 of different sizes, the foaming and curing time may also vary accordingly. The cured inner tube 2 is connected to the tire casing 1 to form the whole. Specifically, an outer annular surface 202 of the inner tube 2 is connected to an inner side surface of the tire casing 1 as a whole, which can prevent the tire casing 1 and the inner tube 2 from loosened or separated from each other during the use of the vehicle wheel 100.

In the above steps S21 and S22, negative-pressure air exhaust is performed through the plurality first exhaust holes 83, which can increase the forming speed of the inner tube 2. It can be understood that there will be less and less air within the first injection cavity 82 during the injection process. When the injection process is nearly completed, there is a small amount of air in the small space remained inside the first injection cavity 82. Compared with the situation where no negative-pressure air exhaust is provided, the very small space remained may not be filled by the second material, and the second material may not enter the first injection cavity 82 to squeeze out the last small amount of air. However, this embodiment can form a negative pressure environment in the first injection cavity 82 through negative-pressure air exhaust, which can be more conducive to air exhaust. In addition, the second material is filled into the first injection cavity 82, so that the first mould 8 is fully filled, so that the tire body (including the tire casing 1 and the inner tube 2) is fuller, and the bubbles or depressions in the tire body can be reduced. In addition, after the second material is injected into the first injection cavity 82, the inner tube 2 is formed by a foaming process. The negative pressure environment in the first injection cavity 82 is also conducive to the foaming and expansion of the second material, which can increase the forming speed of the inner tube 2.

By utilizing both the negative-pressure air exhaust and the centrifugal injection, the material (such as the second material) can be cured and molded better and more evenly, and the density of the resulted product (such as inner tube 2) can be improved, making the parameters of the resulted product (such as inner tube 2) closer to the theoretical value. For example, the actual weight of the product (such as inner tube 2) has an error range of ±5% to ±10% compared to the theoretical weight.

At S3, the whole of the tire casing 1 and the inner tube 2 as a whole are removed. Specifically, after removing the tire casing 1 and the inner tube 2 as a whole from the first mould 8, the excess portions of the first material and/or the second material formed in the first exhaust holes 83, the first injection holes 81 and the like during the molding process are removed, so that the tire casing 1 and the inner tube 2 connected as a whole as required can be obtained, and the main body 24 of the inner tube 2 is received in the receiving groove 103 of the tire casing 1.

In some embodiments, the method for manufacturing the vehicle wheel 100 of the first embodiment further includes the following step S4.

At S4, the tire casing 1 and the inner tube 2 as a whole are mounted on the hub 3.

The tire casing 1 and the inner tube 2 are connected as a whole. The protrusion 23 of the inner tube 2 is engaged in the mounting groove 32 of the hub 3, and the tire casing 1 is located outside the mounting groove 32. In order to improve the connection strength between the inner tube 2 and the hub 3, at least one of the protrusion 23 of the inner tube 2 and the inner wall of the mounting groove 32 may be at least partially coated with an adhesive, and then the tire casing 1 and the inner tube 2 as a whole are mounted on the hub 3.

In the method for manufacturing the vehicle wheel according to the first embodiment of the present disclosure, the tire casing 1 and the inner tube 2 are successively formed by centrifugally injection and curing in the same mould (first mould 8). In addition, both the tire casing 1 and the inner tube 2 contain polyurethane material, so that the tire casing 1 and the inner tube 2 can be in close contact with each other, reducing the risk of the tire casing 1 being loosened or separated from the inner tube 2. In this method, the negative-pressure air exhaust is performed through the first exhaust holes 83 during the centrifugal injection and curing of the tire casing 1 and the inner tube 2, which not only speeds up the curing and forming speed of the tire casing 1 and the inner tube 2, saves the manufacturing time of the vehicle wheel 100, but also makes the tire casing 1 and the inner tube 2 more uniform and dense in structure.

It can be understood that in the first embodiment, since the tire casing 1 and the inner tube 2 are formed as a whole by centrifugal injection and curing in the same mould, the inner surface of the tire casing 1 (i.e., the inner wall of the receiving groove 103) and the outer annular surface 202 of the inner tube 2 are attached to each other, and no specially designed buckling structure between the tire casing 1 and the inner tube 2 is formed.

However, it should be noted that in actual products, due to the influence of factors such as mould shape design or processing errors, the inner surface of the formed tire casing 1 may not be arc-shaped smoothly as shown in FIG. 3. For example, some bubbles in the first material may not be removed, resulting in convex parts on the inner surface of the tire casing 1 formed by curing the first material. The terms “arc-shaped” as described in this application only means substantially arc-shaped. The outer annular surface 202 of the inner tube 2 is attached to the inner surface of the tire casing 1 because the second material covers the inner surface of the tire casing 1. In actual products, the inner surface of the tire casing 1 does not necessarily have an ideal arc shape over the entire circumference.

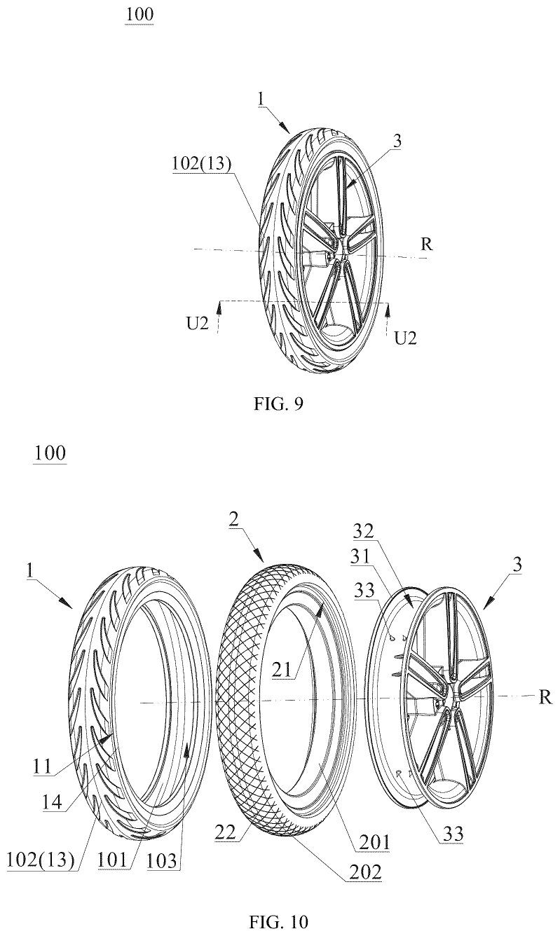

FIG. 9 is a perspective view of a vehicle wheel 100 according to a second embodiment of the present disclosure, and FIG. 10 is an exploded view of the vehicle wheel 100 of FIG. 9.

The vehicle wheel 100 according to the second embodiment is similar to the vehicle wheel 100 of the first embodiment, but mainly has the following differences.

As shown in FIGS. 9 and 10, in some embodiments, the vehicle wheel 100 includes a hub 3, an inner tube 2, and a tire casing 1. The hub 3 has an annular shape. The hub 3 has a mounting groove 32 extending in the circumferential direction. The tire casing 1 and the inner tube 2 are connected as a whole and are sleeved on the hub 3. The inner tube 2 is at least partially received in the mounting groove 32. Specifically, the tire casing 1 has a receiving groove 103. At least a part of the inner tube 2 is received in the receiving groove 103. The inner tube 2 has an outer annular surface 202. The bottom wall of the receiving groove 103 forms an inner surface 101 of the tire casing 1. It should be noted that “the tire casing 1 and the inner tube 2 are connected as a whole” means that the tire casing 1 and the inner tube 2 are sleeved on the hub 3 as a whole. An outer annular surface 202 of the inner tube 2 and an inner surface 101 of the tire casing 1 can be in close contact with each other by at least partially fusing the outer annular surface 202 and the inner surface 101 together, or by pressing the inner surface 101 against the outer annular surface 202.

Still referring to FIGS. 9 to 10, in this embodiment, the tire casing 1 is made of a first material. The first material includes thermoplastic polyurethane (TPU) material. The tire casing 1 has a relatively high density and has good advantages such as good wear resistance, puncture resistance, and support performance, so that the vehicle wheel 100 has a relatively long service life and good quiet performance. Meanwhile, the tire casing 1 made of TPU material can also avoid the problems of blooming and black marks. The inner tube 2 is made of a second material. The second material includes polyurethane (PU) material. The density of the inner tube 2 is less than that of the tire casing 1. Compared with the case where the densities of the inner tube 2 and the tire casing 1 are both high, the inner tube with a lower density can make the overall cost of the vehicle wheel 100 lower and the weight smaller.

In some embodiments, as shown in FIGS. 9 to 11, the hub 3, the inner tube 2 and the tire casing 1 have the same rotation axis R. One of the outer surface 102 of the tire casing 1 and the hub 3 is provided with a first concave portion 11, and the other of the outer surface 102 of the tire casing 1 and the hub 3 is provided with a first convex portion 31. The first convex portion 31 is engaged with the first concave portion 11. One of the inner surface 101 of the tire casing 1 and the inner tube 2 is provided with a second convex portion 12, and the other of the inner surface 101 of the tire casing 1 and the inner tube 2 is provided with a second concave portion 21. The second convex portion 12 and the second concave portion 21 are engaged with each other and located in the mounting groove 32. In this embodiment, the outer surface 102 of the tire casing 1 is provided with the first concave portion 11, and the first concave portion 11 is in an annular shape. Correspondingly, the hub 3 is provided with the first convex portion 31, the first convex portion 31 is in an annular shape. The inner surface 101 of the tire casing 1 is provided with the second convex portion 12, the second convex portion 12 is in an annular shape. Correspondingly, the inner tube 2 is provided with the second concave portion 21, and the second concave portion 21 is in an annular shape. The first convex portion 31 is engaged with the first concave portion 11, the second convex portion 12 and the second concave portion 21 are engaged with each other and located in the mounting groove 32, so that the connection strength between the tire casing 1 and the hub 3 and between the tire casing 1 and the inner tube 2 can be enhanced, the inner tube 2 can be prevented from being loosened or separated from the tire casing 1, and the tire casing 1 can be prevented from being loosened or separated from the hub 3 during the use of the vehicle wheel 100, so that the inner tube 2 and the tire casing 1 can be more firmly sleeved on the hub 3. In addition, since the engaging position of the second convex portion 12 and the second concave portion 21 is located in the mounting groove 32, the tire casing 1 and the inner tube 2 may be loosened or separated from each other only when the tire casing 1 is separated outward relative to the hub 3. Therefore, the engagement between the first convex portion 31 and the first concave portion 11 indirectly increases the stability of the engagement between the second convex portion 12 and the second concave portion 21, making it difficult for the tire casing 1 and the inner tube 2 to be loosened or separated from each other.

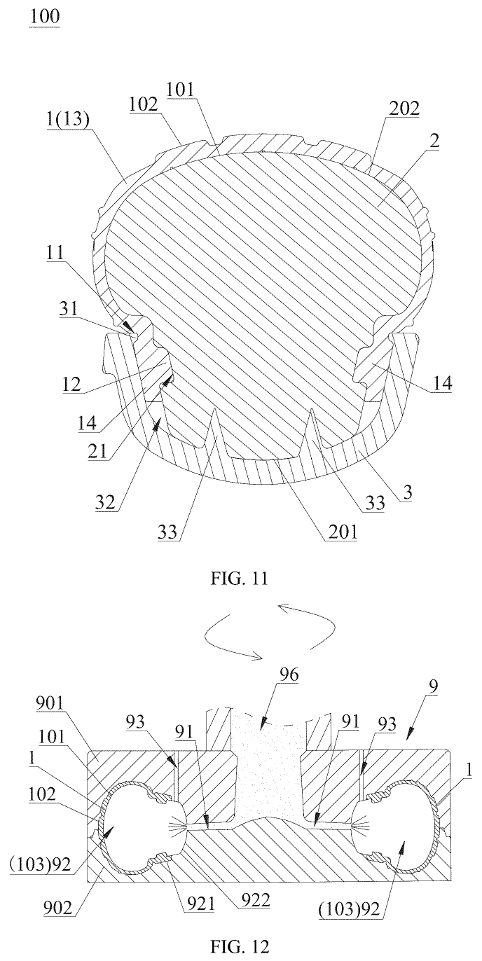

As shown in FIGS. 10 and 11, the tire casing 1 includes a first ring portion 13 and two second ring portions 14 disposed at two ends of the first ring portion 13. The first ring portion 13 and the second ring portion 14 are both in an annular shape. The second ring portion 14 is sandwiched between the hub 3 and the inner tube 2. The first ring portion 13 is located outside the mounting groove 32. The outer surface 102 of the tire casing 1 is provided with the first concave portion 11. The first convex portion 31 is disposed on an opening of the mounting groove 32 of the hub 3. Specifically, the first concave portion 11 is formed on the outer surface 102 of the second ring portion 14. The first concave portion 11 is recessed inward from the outer surface 102 in the direction substantially parallel to the rotation axis R. The outer surfaces 102 of the two second ring portions 14 are respectively pressed against the sidewall of the mounting groove 32. The second convex portion 12 is disposed on each of the inner surfaces 101 of the two second ring portions 14. Correspondingly, the second concave portion 21 is disposed on the outer annular surface 202 of the inner tube 2, and recessed inward from the outer annular surface 202 in the direction substantially parallel to the rotation axis R. In this embodiment, the second convex portion 12 is more adjacent to the bottom wall of the mounting groove 32 than the first concave portion 11. That is, a distance between the second convex portion 12 and the rotation axis R is less than a distance between the first concave portion 11 and the rotation axis R.

The inner tube 2 has an inner annular surface 201 and an outer annular surface 202 opposite to the inner annular surface 201. The tire casing 1 covers the inner tube 2, and the inner surface 101 of the tire casing 1 is pressed against the outer annular surface 202 of the inner tube 2. A portion of the inner tube 2 extends out of the tire casing 1 and forms the inner annular surface 201. The inner annular surface 201 is pressed against the bottom wall of the mounting groove 32 of the hub 3. The mounting groove 32 of the hub 3 is provided with thorns 33. The thorns 33 extend through the inner annular surface 201 and are embedded in the inner tube 2. By providing the thorns 33 embedded in the inner tube 2, the connection strength between the inner tube 2 and the hub 3 is enhanced, and the inner tube 2 and the tire casing 1 are further prevented from being loosened or separated from the hub 3, thereby improving the service life of the vehicle wheel 100.

In some embodiments, as shown in FIG. 10, the inner surface 101 of the tire casing 1 is provided with a pattern (not shown). The pattern is arranged along the inner periphery of the tire casing 1. The pattern is, for example, a prismatic pattern. The pattern is engaged with the outer annular surface 202 of the inner tube 2, that is, the outer annular surface 202 of the inner tube 2 is provided with another pattern 22 engaged with the above pattern. The pattern 22 may be a cross pattern. In this way, the friction between the inner tube 2 and the tire casing 1 can be increased, thereby preventing the tire casing 1 and the inner tube 2 from rotating relative to each other.

The present disclosure provides a method for manufacturing the vehicle wheel 100 of the second embodiment. The method for manufacturing the vehicle wheel 100 of the second embodiment mainly differs from the method for manufacturing the vehicle wheel of the first embodiment in the following aspects.

Referring to FIG. 14, the method for manufacturing the vehicle wheel 100 according to the second embodiment of the present disclosure includes the following steps S1 to S3.

At S1, a first material is cured and molded to form the tire casing 1. The tire casing 1 has a receiving groove 103. The step S1 of curing and molding the first material to form the tire casing 1 specifically includes the following steps S11′ to S14′ (see FIG. 24).

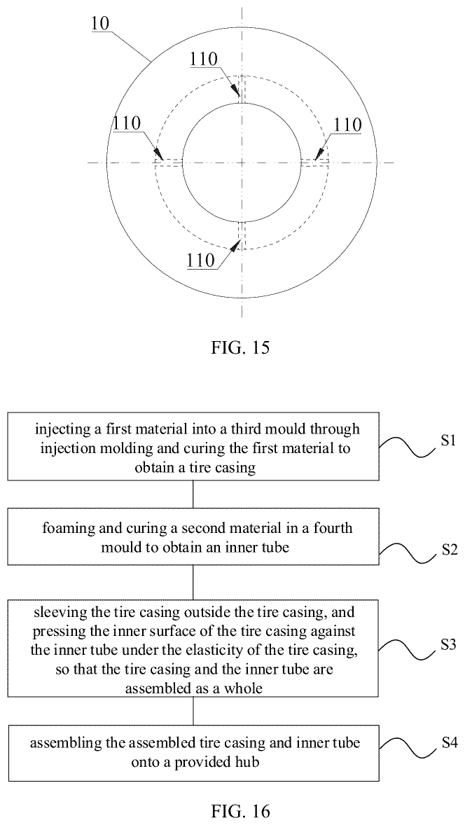

At S11′, a tire casing mould (such as a third mould 10 shown in FIG. 15) is provided. It should be noted that the tire casing mould in this embodiment is different from the first mould 8 used to manufacture the vehicle wheel 100 of the first embodiment.

In this embodiment, the tire casing mould is provided with a tire injection cavity. The tire injection cavity is used for forming the tire casing by curing.

At S12′, the first material is injected into the tire casing mould through an injection molding machine.

In this embodiment, the first material fills the tire injection cavity of the tire casing mould. The first material includes, for example, thermoplastic polyurethane (TPU). The first material can be injected into the tire casing mould by the injection molding machine, so that the wall thickness of the tire casing 1 is more uniform by injection molding, which is convenient for realizing the thinness of the tire casing 1 and shortening the curing period of forming the tire casing.

At S13′, the first material is cooled and cured, and the tire casing 1 is obtained.

The cured tire casing 1 has the receiving groove 103. The receiving groove 103 is annular and configured for curing and molding and receiving the inner tube 2. The sidewall of the receiving groove 103 (i.e., the inner surface 101 of the tire casing 1) is provided with a second convex portion 12. The wall thickness of the tire casing 1 is in a range of 2.0 mm to 4.0 mm. In an example, the wall thickness of the tire casing 1 is about 2.4 mm. In this embodiment, the first material is cooled and cured, and there is no need to add a foaming agent to the first material for foaming and curing. In this way, the tire casing 1 formed by curing can be relatively dense and have better wear resistance.

It should be noted that in the above steps S12 and S13, there is no need to perform negative-pressure air exhaust, which makes the curing process of forming the tire casing 1 simpler. It can be understood that the first material fills the tire injection cavity to form the tire casing 1, and the shape and wall thickness of the tire casing 1 can be controlled by setting the shape of the tire injection cavity. This embodiment makes the wall thickness of the tire casing 1 more controllable, reduces the influence of uncontrollable factors on the wall thickness of the tire casing 1 during the molding process, which is beneficial to molding the tire casing 1 with uniform wall thickness.

At S14′, the tire casing 1 is removed from the tire casing mould. The tire casing 1 can be used in the curing step of the inner tube 2 after removing the excess portions of the tire casing 1.

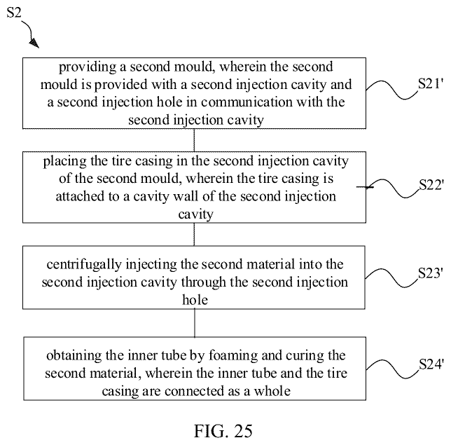

At S2, a second material is centrifugally injected into the receiving groove 103 of the tire casing 1, and cured to form the inner tube 2. Step S2 specifically includes the following steps S21′ to S24′ (see FIG. 25).

At S21′, a second mould 9 is provided. As shown in FIG. 12, the second mould 9 is provided with a second injection cavity 92 and second injection holes 91 in communication with the second injection cavity 92.

Specifically, the second mould 9 is in an annular shape. It should be noted that the annular shape herein includes a circular ring shape, a rectangular ring shape, etc. Referring to FIGS. 12 and 13, the second mould 9 includes a second upper mould 901 and a second lower mould 902. The second upper mould 901 and the second lower mould 902 are detachably connected to each other, and form the second injection cavity 92. The second mould 9 has a second main channel 96. The second main channel 96 extends substantially in the longitudinal direction, that is, along the rotation axis R of the vehicle wheel 100. The second injection holes 91 extend through the sidewall of the second main channel 96 to the inner wall of the second injection cavity 92. That is, the second injection holes 91 are in communication with the second main channel 96 and the second injection cavity 92, respectively. The second injection hole 91 can be disposed on the second upper mould 901, or on the second lower mould 902, or at the connection between the second upper mould 901 and the second lower mould 902, and which is not limited herein. In some embodiments, as shown in FIG. 13, a plurality of, such as four, five, or six, second injection holes 91 may be provided. The plurality of second injection holes 91 are evenly distributed on the second mould 9 in the circumferential direction.

At S22′, the tire casing 1 is placed in the second injection cavity 92 of the second mould 9, and the tire casing 1 is attached to the cavity wall of the second injection cavity 92.

As shown in FIGS. 12 to 13, in the second mould 9, a portion of the cavity wall of the second injection cavity 92 that is in contact with the outer surface 102 of the tire casing 1 serves as a first cavity wall 921, and the other portion of the cavity wall of the second injection cavity 92 that is not in contact with the tire casing 1 serves as a second cavity wall 922. The second injection hole 91 extends through the second cavity wall 922 and is in communication with the second injection cavity 92. The second mould 9 is provided with a second exhaust hole 93 for negative-pressure air exhaust. The second exhaust hole 93 extends through the second cavity wall 922 and is in communication with the second injection cavity 92. A plurality of second exhaust holes 93 are provided. Negative-pressure air exhaust can be performed in the second injection cavity 92 through these second exhaust holes 93. The plurality of second exhaust holes 93 are disposed on the second mould 9 at positions corresponding to the portions of the inner tube 2 protruding from the receiving groove 103 of the tire casing 1, that is, opening ends of the plurality of second exhaust holes 93 are all located on the second cavity wall 922. In this way, the cross-section formed by cutting off the excess portions of the inner tube 2 of the vehicle wheel 100 formed in the plurality of second exhaust holes 93 can be hidden in the mounting groove 32 of the hub 3, thereby making the vehicle wheel 100 more aesthetic.

Specifically, referring to FIG. 12, the second exhaust holes 93 may extend in a substantially longitudinal direction, i.e., a direction parallel to the rotation axis R of the vehicle wheel 100. For example, the second exhaust hole 93 extends from the upper surface of the second mould 9 to the inner wall of the second injection cavity 92. The second exhaust hole 93 may also extend in a substantially transverse direction, i.e., a direction parallel to the radial direction of the vehicle wheel 100. Specifically, in some embodiments, the second exhaust hole 93 may be distributed above or below the second injection holes 91 in the longitudinal direction. Referring to FIG. 13, the plurality of second exhaust holes 93 may also be located on the same transverse plane as the plurality of second injection holes 91, and the plurality of second exhaust holes 93 and the plurality of second injection holes 91 may be spaced apart from each other in the circumferential direction, which is not limited herein.

At S23′, the second material is centrifugally injected into the second injection cavity 92 through the second injection holes 91, so that the receiving groove 103 of the tire casing 1 is filled with the second material.

The second material includes polyurethane (PU), for example. The density of the inner tube is less than that of the tire casing 1. The density of the inner tube 2 is in a range of 0.2 g/cm³ to 0.6 g/cm³. A foaming agent is required to be added to the second material to facilitate foaming and curing. In this embodiment, the first material configured to be cured to form the tire casing 1 and the second material used to form the inner tube 2 are both selected from the polyurethane series, for example, the first material includes thermoplastic polyurethane (TPU) material, and the second material includes polyurethane (PU) material. After the second material is injected and covered on the inner surface 101 of the tire casing 1, the second material and the inner surface 101 of the tire casing 1 can be well fused together, so that the formed tire casing 1 and the formed inner tube 2 by curing can be in closer contact with each other, avoiding the formation of a gap between the inner tube 2 and the tire casing 1, and reducing the risk of the tire casing 1 being loosened or separated from the inner tube 2.

At S24′, the second material is foamed and cured, and the inner tube 2 is obtained, and the inner tube 2 is connected to the tire casing 1 as a whole. The foaming and curing time of the second material is in a range of about 3 minutes to 4 minutes.

In steps S23 and S24, it is necessary to perform negative-pressure air exhaust through the second exhaust holes 93 to keep the pressure in the second injection cavity 92 less than 0, for example, keep the pressure in the second injection cavity 92 at about −0.05 MPa. Compared with the situation where no negative-pressure air exhaust is provided, the negative-pressure air exhaust can increase the curing speed of the inner tube 2. By combining negative-pressure air exhaust and centrifugal injection, the material (such as the second material) can be better cured and molded, and the dense of the product can be improved, so that the parameters of the product (such as the inner tube 2) is closer to the theoretical value. For example, the actual weight of the inner tube 2 has an error range of ±5% to ±10% compared to the theoretical weight.

At S3, the tire casing 1 and the inner tube 2 are removed as a whole. Specifically, after removing the tire casing 1 and the inner tube 2 as a whole from the second mould 9, the excess portions of the second material corresponding to the second exhaust holes 93, the second injection hole 91 and the like are removed, and the tire casing 1 and the inner tube 2 connected as a whole as required can be obtained.

In some embodiments, the method for manufacturing the vehicle wheel 100 of the second embodiment further includes the following step S4.

At S4, the tire casing 1 and the inner tube 2 are mounted on the hub 3 as a whole.

The inner annular surface 201 of the inner tube 2 is attached to the groove bottom of the mounting groove 32. The second ring portion 14 of the tire casing 1 is received in the mounting groove 32. The first convex portion 31 of the hub 3 is engaged with the first concave portion 11 of the tire casing 1. In some embodiments, in order to improve the connection strength between the inner tube 2 and the hub 3, at least one of the inner annular surface 201 of the inner tube 2 and the bottom wall of the mounting groove 32 may be at least partially coated with an adhesive, and then the tire casing 1 and the inner tube 2 are mounted on the hub 3 as a whole.

In the methods for manufacturing the vehicle wheels 100 in the first and second embodiments as described above, it is required to first form the tire casing 1 of the vehicle wheel 100, and then form the inner tube 2 of the vehicle wheel 100 by centrifugally injection into the receiving groove 103 of the tire casing 1. After the inner tube 2 is formed by curing, the inner tube 2 and the tire casing 1 are connected as a whole, thereby enabling the inner tube 2 to be in close contact with the tire casing 1, and avoiding the tire casing 1 from being loosened or separated from the inner tube 2.

It should be noted that the vehicle wheel shown in FIGS. 9 to 11 can be obtained by the method including steps S1 to S4 of the second embodiment, and can also be obtained by the following process: the tire casing 1 is formed by injection molding, and the inner tube 2 is formed by foaming and curing in the mould. After the tire casing 1 and the inner tube 2 are formed separately, the tire casing 1 is sleeved outside the inner tube 2, and then the tire casing 1 and the inner tube 2 are sleeved on the hub 3 as a whole. The inner tube 2 can be constrained by the elastic force of the tire casing 1, so that the outer annular surface 202 of the inner tube 2 and the inner surface 101 of the tire casing 1 are attached to each other. In this case, for example, the first material for the tire casing 1 can include thermoplastic polyurethane (TPU) material, and the second material for the inner tube 2 can include ethylene-vinyl acetate copolymer (EVA) material. At least one of the inner wall surface of the tire casing 1 and the outer wall surface of the inner tube 2 may be provided with a pattern, such as a diamond cross pattern, to increase the friction between the tire casing 1 and the inner tube 2 and reduce the relative rotation between the tire casing 1 and the inner tube 2. In other embodiments, an adhesive may be applied between the tire casing 1 and the inner tube 2 as needed to increase the connection stability between the tire casing 1 and the inner tube 2. It can be understood that the shape of the tire casing 1 (for example, including the first concave portion 11 and the second convex portion 12) can be formed by designing a mould for the injection molding, and the shape of the inner tube 2 (for example, including the second concave portion 21) can be formed by designing a mould for foaming and curing the second material.

Specifically, according to a modification of the second embodiment of the present disclosure, as shown in FIGS. 9 to 11 and FIGS. 15 to 16, a vehicle wheel 100 includes a hub 3, an inner tube 2 and a tire casing 1. The hub 3 has an annular shape. The hub 3 has a mounting groove 32 extending in the circumferential direction. The inner tube 2 is sleeved on the hub 3 and is at least partially received in the mounting groove 32. The tire casing 1 covers the inner tube 2, and an outer surface 101 of the tire casing 1 is pressed against the inner tube 2. The hub 3, the inner tube 2 and the tire casing 1 have the same rotation axis R.

The tire casing 1 is made of a first material. The first material includes a thermoplastic polyurethane (TPU) material. The tire casing 1 made of TPU material can solve problems of blooming and contact or migration staining (i.e., leaving black marks on the ground where the vehicle wheels pass) on a tire casing surface of a vehicle wheel with a tire casing made of rubber after a certain period of use. In addition, the tire casing 1 also has the advantages of good wear resistance, puncture resistance, support performance, etc., so that the vehicle wheel has a relatively long service and good quiet performance. The inner tube 2 is made of a second material. The second material includes an ethylene-vinyl acetate (EVA) copolymer material. Since the EVA material has high elasticity, the inner tube 1 has good shock resistance, so that the vehicle wheel 100 can run more smoothly even when driving on a relatively bumpy road.

One of the outer surface 102 of the tire casing 1 and the hub 3 is provided with a first concave portion 11, and the other of the outer surface 102 of the tire casing 1 and the hub 3 is provided with a first convex portion 31. The first convex portion 31 is engaged with the first concave portion 11. One of the inner surface 101 of the tire casing 1 and the inner tube 2 is provided with a second convex portion 12, and the other of the inner surface 101 of the tire casing 1 and the inner tube 2 is provided with a second concave portion 21. The second convex portion 12 is engaged with the second concave portion 21, with an engaging position in the mounting groove 32. In this modified embodiment, the outer surface 102 of the tire casing 1 is provided with the first concave portion 11, and the first concave portion 11 is in an annular shape. Correspondingly, the hub 3 is provided with the first convex portion 31, and the first convex portion 31 is in an annular manner. The inner surface 101 of the tire casing 1 is provided with the second convex portion 12, and the second convex portion 12 is in an annular shape. Correspondingly, the inner tube 2 is provided with the second concave portion 21, and the second concave portion 21 is in an annular shape. By engaging the first convex portion 31 with the first concave portion 11, and engaging the second convex portion 12 with the second concave portion 21 with the engaging position in the mounting groove 32, the connection strength between the tire casing 1 and the hub 3, and between the tire casing 1 and the inner tube 2 can be enhanced. As such, the inner tube 2 and the tire casing 1 can be prevented from being loosened or separated from each other, and the tire casing 1 and the hub 3 can be prevented from being loosened or separated from each other during the use of the vehicle wheel 100, so that the inner tube 2 and the tire casing 1 can be more firmly sleeved on the hub 3. In addition, since the engaging position of the second convex portion 12 with the second concave portion 21 is located in the mounting groove 32, the tire casing 1 and the inner tube 2 may be loosened or separated from each other only when the tire casing 1 is separated outwards relative to the hub 3, so the engagement between the first convex portion 31 and the first concave portion 11 indirectly enhances the engaging stability between the second convex portion 12 and the second concave portion 21 21, so that the tire casing 1 and the inner tube 2 are not easy to be loosened or separated from each other.

As shown in FIG. 11, the tire casing 1 includes a first ring portion 13 and two second ring portions 14 disposed at two ends of the first ring portion 13. The first ring portion 13 and the second ring portion 14 are both in an annular shape. The second ring portion 14 is sandwiched between the hub 3 and the inner tube 2. The first ring portion 13 is located outside the mounting groove 32. The outer surface 102 of the tire casing 1 is provided with the first concave portion 11. The first convex portion 31 is disposed on an opening of the mounting groove 32 of the hub 3. Specifically, the first concave portion 11 is formed on the outer surface 102 of the second ring portion 14. The first concave portion 11 is recessed inward from the outer surface 102 in the direction substantially parallel to the rotation axis R. The outer surfaces 102 of the two second ring portions 14 are respectively pressed against the sidewall of the mounting groove 32. The second convex portion 12 is disposed on each of the inner surfaces 101 of the two second ring portions 14. Correspondingly, the second concave portion 21 is disposed on the outer annular surface 202 of the inner tube 2, and recessed inward from the outer annular surface 202 in the direction substantially parallel to the rotation axis R. In this modified embodiment, the second convex portion 12 is more adjacent to the bottom wall of the mounting groove 32 than the first concave portion 11. That is, the distance between the second convex portion 12 and the rotation axis R is less than the distance between the first concave portion 11 and the rotation axis R.

Still referring to FIGS. 9 to 11, the inner tube 2 has an inner annular surface 201 and an outer annular surface 202 opposite to the inner annular surface 201. The tire casing 1 covers the inner tube 2, and the inner surface 101 of the tire casing 1 is pressed against the outer annular surface 202 of the inner tube 2. A portion of the inner tube 2 extends out of the tire casing 1 and forms the inner annular surface 201. The inner annular surface 201 is pressed against the bottom wall of the mounting groove 32 of the hub 3. The mounting groove 32 of the hub 3 is provided with a plurality of thorns 33. The thorns 33 extend through the inner annular surface 201 and are embedded in the inner tube 2. By providing the thorns 33 embedded in the inner tube 2, the connection strength between the inner tube 2 and the hub 3 is enhanced, and the inner tube 2 and the tire casing 1 are further prevented from being loosened or separated from the hub 3, thereby improving the service life of the vehicle wheel 100.

As shown in FIG. 10, the outer annular surface 202 of the inner tube 2 is provided with a cross pattern 22. The cross pattern 22 is arranged on the outer periphery of the inner tube 2 to increase the friction between the inner tube 2 and the tire casing 1, thereby preventing the tire casing 1 and the inner tube 2 from rotating and rubbing against each other. The cross pattern 22 is, for example, a diamond pattern. In some other embodiments, the inner surface 101 of the tire casing 1 may be provided with the cross pattern 22, and the cross pattern 22 is arranged on the inner periphery of the tire casing 1. In some other embodiments, the outer annular surface 202 of the inner tube 2 and the inner surface 101 of the tire casing 1 may each be provided with cross pattern 22. The cross pattern 22 on the outer annular surface 202 of the inner tube 2 and the cross pattern 22 on the inner surface 101 of the tire casing 1 may be the same or different. In the process of sleeving the tire casing 1 on the inner tube 2, it is not necessary to align the cross pattern 22 on the outer annular surface 202 of the inner tube 2 with the cross pattern 22 on the inner surface 101 of the tire casing 1. In some other embodiments, an adhesive may be further provided between the outer annular surface 202 of the inner tube 2 and the inner surface 101 of the tire casing 1 to increase the connection strength between the inner tube 2 and the tire casing 1.

Referring to FIGS. 15 to 16, a method for manufacturing the vehicle wheel 100 according to the modified embodiment of the present disclosure includes the following steps S1 to S4.

At S1, a first material is injected into a third mould 10 through injection molding and then cured to obtain a tire casing 1. The first material includes TPU material.

Specifically, the TPU solid raw material is heated and melted, and is then injected and filled into the third mould 10 by an injection molding machine, and the tire casing 1 is obtained after the TPU material is cured and molded. The wall thickness of the tire casing 1 is in a range of 2.0 mm to 3 mm, and specifically, the wall thickness of the tire casing 1 is about 2.4 mm. The curing time is in a range of 40 seconds to 80 seconds, and specifically, the curing time is about 70 seconds. Referring to FIG. 15, in this modified example, the injection molding machine (not shown) can fill the TPU material into the third mould 10 by using a four-point feeding method, i.e., four feeding holes 110 being provided on the third mould 10. In other embodiments, the position and number of the feeding holes 110 can also be provided according to the product size, shape, etc. The tire casing 1 made by injection molding has a uniform wall thickness, and no foaming agent needs to be added, which not only makes the tire casing 1 have good wear resistance, but also reduces costs.

At S2, a second material is foamed and cured in a fourth mould (not shown) to obtain an inner tube 2. The second material includes EVA material.

Specifically, the EVA material is foamed and molded in the fourth mould, so as to form the inner tube 2. The EVA inner tube 2 obtained by foaming has good elasticity and light weight. The inner wall of the fourth mould can be provided with a pattern model in advance. The EVA material is foamed and molded in the fourth mould. The outer annular surface 202 of the formed inner tube 2 can have a pattern corresponding to the pattern model of the fourth mould.

Step S1 and step S2 may be performed in no particular order. Specifically, step S1 and step S2 may be performed simultaneously, step S1 may be performed first, or step S2 may be performed first. In other words, step S1 and step S2 may be performed in parallel or sequentially.

At S3, the tire casing 1 is sleeved outside the tire casing 2, and the inner surface 101 of the tire casing 1 is pressed against the inner tube 2 under the elasticity of the tire casing 1. The two second convex portions 12 of the tire casing 1 are respectively engaged in the two second concave portions 21 of the inner tube 2, so that the tire casing 1 and the inner tube 2 can be assembled as a whole.

In order to make the connection between the tire casing 1 and the inner tube 2 more firmly and avoid separation of the tire casing 1 from the inner tube 2, before step S3, an adhesive can also be applied to the inner side surface of the tire casing 1 and/or the outer annular surface 202 of the inner tube 2, and then the tire casing 1 is used to cover the inner tube 2.

At S4, the assembled tire casing 1 and inner tube 2 are assembled onto the hub 3, thereby completing the assembly of the vehicle wheel 100.

In the vehicle wheel according to the modified example of the second embodiment of the present disclosure, the tire casing is made of the first material including TPU material, which can avoid the problems of blooming and contact or migration staining on the tire casing surface of the vehicle wheel after a certain period of use. In addition, the tire casing also has the advantages of good wear resistance, puncture resistance, support performance, etc., so that the vehicle wheel has a relatively long service and good quiet performance. The inner tube is made of the second material including ethylene-vinyl acetate (EVA) copolymer material. Since the EVA material has high elasticity, the inner tube has good shock resistance, so that the vehicle wheel can run more smoothly even when driving on a relatively bumpy road. In addition, in some embodiments, it is possible to further set the density of the inner tube to be less than that of the tire casing, which not only ensures the good wear resistance and support performance, etc., of the vehicle wheel, but also reduces the overall weight and manufacturing cost of the vehicle wheel.

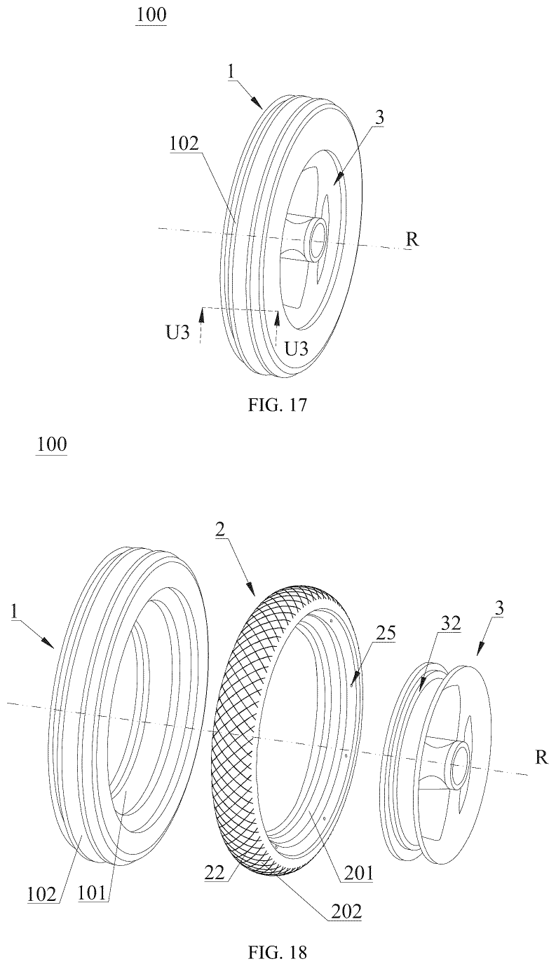

FIG. 17 is a perspective view showing a vehicle wheel 100 according to a third embodiment of the present disclosure, and FIG. 18 is an exploded view of the vehicle wheel 100 according to the third embodiment of the present disclosure. The vehicle wheel 100 of the third embodiment differs from the vehicle wheels 100 of the first and second embodiments described above mainly in the following aspects.

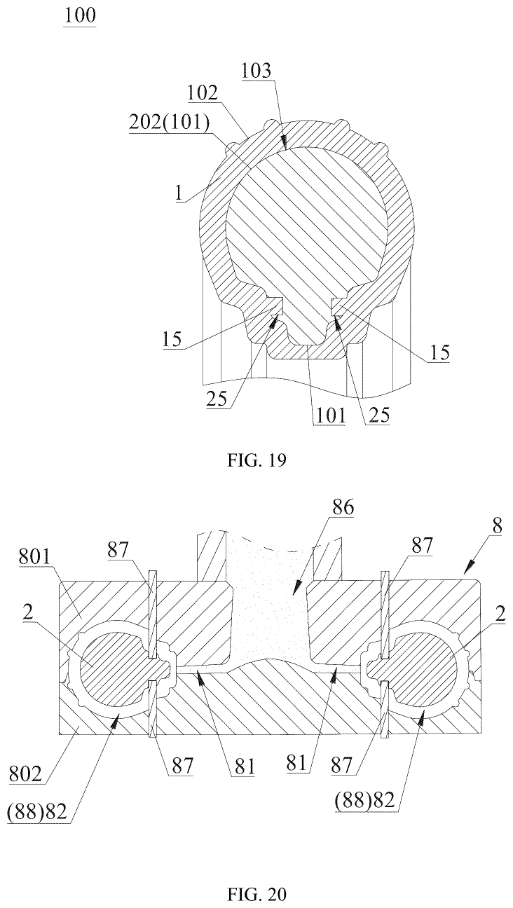

As shown in FIGS. 17 to 19, the vehicle wheel 100 includes a hub 3, an inner tube 2 and a tire casing 1. The tire casing 1 covers the tire casing 2, that is, the inner tube 2 is received in the tire casing 1. The tire casing 1 is sleeved on the hub 3 and is at least partially engaged in a mounting groove 32 of the hub 3. An inner surface 101 of the tire casing 1 is tightly attached to the outer annular surface 202 of the inner tube 2. Referring to FIGS. 18 to 19, in some embodiments, the inner tube 2 is provided with a plurality of positioning holes 25, and the tire casing 1 is provided with a plurality of positioning protrusions 15 that can be received in the corresponding positioning holes 25. In this way, the connection strength between the tire casing 1 and the inner tube 2 can be enhanced, and the inner tube 2 can be conveniently fixed in the process of forming the tire casing 1. In other unillustrated embodiments, the inner tube 2 may not be provided with the positioning holes 25, and accordingly, the tire casing 1 may not be provided with the positioning protrusions 15, which is not limited herein. The tire casing 1 contains a polyurethane (PU) material, and the inner tube 2 contains an ethylene-vinyl acetate copolymer (EVA) material.

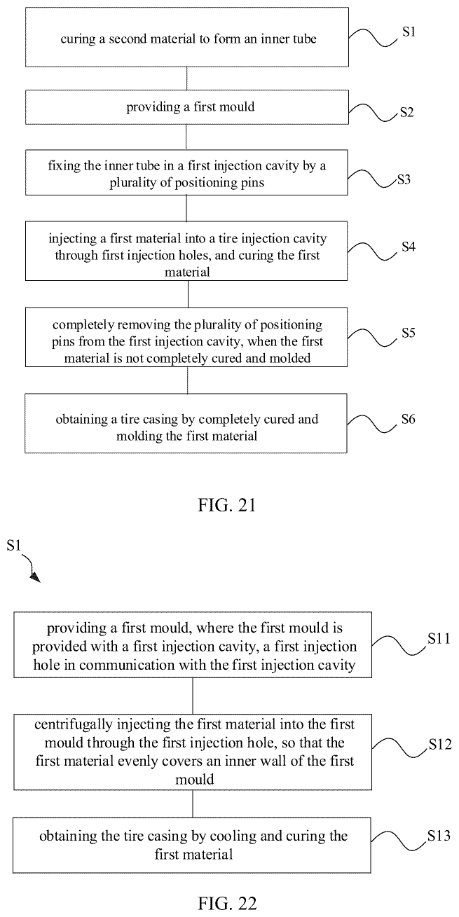

The present disclosure further provides a method for manufacturing the vehicle wheel 100 of the third embodiment. FIG. 21 is a flowchart of the method for manufacturing the vehicle wheel 100 according to the third embodiment of the present disclosure.

As shown in FIG. 21, the method for manufacturing the vehicle wheel 100 of the third embodiment includes the following steps S1 to S5.

At S1, a second material is cured to form the inner tube 2.

The inner tube 2 has a plurality of positioning holes 25. The plurality of positioning holes 25 are distributed in the circumferential direction of the inner tube 2 of the vehicle wheel 100. Specifically, the plurality of positioning holes 25 are respectively distributed on the upper surface and the lower surface of the inner tube 2. More specifically, the plurality of positioning holes 25 are evenly distributed on the upper surface and the lower surface of the inner tube 2. The second material includes, for example, ethylene-vinyl acetate copolymer (EVA). The inner tube 2 further has an outer annular surface 202. The outer annular surface 202 is provided with a pattern. In other embodiments, the inner tube 2 may not be provided with the positioning holes 25, and which is not limited herein.

At S2, a first mould 8 is provided.

As shown in FIG. 20, the first mould 8 is provided with a first injection cavity 82, first injection holes 81 in communication with the first injection cavity 82, and a plurality of positioning pins 87 that can be partially inserted into the first injection cavity 82. The first mould 8 includes a first upper mould 801 and a first lower mould 802. The first upper mould 801 and the first lower mould 802 are detachably connected to each other and encloses the first injection cavity 82. The first upper mould 801 is provided with a plurality of positioning pins 87, and the first lower mould 802 is provided with a plurality of positioning pins 87. Specifically, the plurality of positioning pins 87 on the first upper mould 801 and the plurality of positioning pins 87 on the first lower mould 802 may be arranged in a one-to-one correspondence, or may be arranged in a staggered manner. Correspondingly, the plurality of positioning holes 25 located on the upper surface of the inner tube 2 and the plurality of positioning holes 25 located on the lower surface of the inner tube 2 may be arranged in a one-to-one correspondence, or may be arranged in a staggered manner. For the positions of the first injection holes 81 of the third embodiment, reference may be made to the positions of the first injection hole 81 of the first mould 8 involved in the method for manufacturing the vehicle wheel 100 of the first embodiment, and which will not be repeatedly described in detail herein.

It should be noted that, in the third embodiment, the above steps S1 and S2 are performed with no particular order.

At S3, the inner tube 2 is fixed in the first injection cavity 82 by the plurality of positioning pins 87, so that a tire casing injection cavity 88 is formed between the inner wall of the first injection cavity 82 and the inner tube 2.

The outer annular surface 202 of the inner tube 2 is not in contact with the inner wall of the first injection cavity 82, so as to allow the tire casing 1 that may completely cover the inner tube 2 to be formed in the tire casing injection cavity 88. In this embodiment, the inner tube 2 is fixed in the first injection cavity 82 by inserting the positioning pins 87 into the corresponding positioning holes 25. In this way, the inner tube 2 may be fixed in the first injection cavity 82 more stably to prevent the inner tube 2 from moving in the first injection cavity 82. In some other embodiments, the positioning holes 25 may not be disposed on the inner tube 2, and the plurality of positioning pins 87 may be respectively inserted into the first injection cavity 82 and respectively abut against the surface of the inner tube 2 in the upward and downward directions, so as to fix the inner tube 2 in the first injection cavity 82 of the first mould 8, which is not limited herein.

At S4, the first material is injected into the tire injection cavity 88 through the first injection holes 81, and the first material is cured.

The first material includes, for example, polyurethane (PU). A foaming agent is added to the first material to form the tire casing 1 by foaming and curing.

At S5, the plurality of positioning pins 87 are completely removed from the first injection cavity 82 when the first material is not completely cured and molded, so as to allow the first material to enter the space where the plurality of positioning pins 87 are removed.

“When the first material is not completely cured and molded” used herein means that the tire casing 1 is not completely formed. There are different methods to implement steps S4 and S5, such as the following three methods:

The first method is that during the positioning pins 87 positioning the inner tube 2, a part of the first material is firstly injected to fill the space in the tire casing injection cavity 88 except the space occupied by the positioning pin 87. When this part of the first material is foamed for a certain period of time and has not yet been completely foamed and completely cured, the positioning pins 87 are removed from the first injection cavity 82 at one time, and then, the other part of the first material is continuously injected into the tire casing injection cavity 88, so that the first material flows into the space previously occupied by the positioning pins 87, so that the hole formed due to the positioning pins 87 can be filled.

The second method is that, during the positioning pins 87 positioning the inner tube 2, a part of the first material is first injected to fill the space in the tire casing injection cavity 88 except the space occupied by the positioning pins 87. When this part of first material is foamed for a certain period of time and has not yet been completely foamed and completely cured, the plurality of positioning pins 87 are removed from the first injection cavity 82 in multiple times, and the first material is injected into the tire casing injection cavity 88 in multiple times until all the positioning pins 87 are removed from the tire casing injection cavity 88 and the first material fills the space previously occupied by the plurality of positioning pins 87.

The third method is that, a part of the first material is first filled into the tire casing filling cavity 88. When this part of the first material is foamed for a certain period of time and has not yet been completely foamed, the positioning pins 87 are removed from the tire casing filling cavity 88 at one time or in multiple times, so that the first material can fill the space previously occupied by the positioning pins 87 during the process of foaming.

The above three methods are only examples for illustrative purposes, and the present disclosure is not limited to using one of the above three methods to implement steps S4 and S5.

As shown in FIG. 21, the method for manufacturing the vehicle wheel 100 of the third embodiment of the present disclosure further includes the following step S6.

At S6, a tire casing 1 is obtained the first material is completely cured and molded.

The tire casing 1 covers the inner tube 2 and is connected to the inner tube 2 as a whole, which can prevent the inner tube 2 and the tire casing 1 from being loosened or separated from each other. In this embodiment, the tire casing 1 has the plurality of positioning protrusions 15, which are formed by curing the first material filled into the plurality of positioning holes 25 of the inner tube 2. The plurality of positioning protrusions 15 are received in the corresponding positioning holes 25. In this way, the positioning holes 25 are filled, and the formation of depressions or holes on the outer surface 102 of the tire casing 1 can be avoided, making the tire casing 1 more aesthetic.

In other embodiments, the inner tube 2 may not have the positioning hole 25, and the positioning pins 87 abut against the surface of the inner tube 2 to position the inner tube 2. When the positioning pins 87 are removed, the first material fills the space previously occupied by the positioning pins 87, and thus the tire casing 1 formed by curing does not have the positioning protrusions 15. However, it is still possible to avoid leaving a depression on the portions of the formed tire casing 1 corresponding to the positioning pins 87, which is not limited herein.

An embodiment of the present disclosure further provides a child carrier. The child carrier includes the vehicle wheel 100 in any of the above embodiments. The child carrier may be a stroller, a crib, etc. The child carrier includes a carrier body (not shown) and the vehicle wheels 100 mounted on the carrier body. The child carrier can be conveniently moved by the vehicle wheels 100.

In the methods for manufacturing the vehicle wheel, the vehicle wheels and the child carrier in the first to third embodiments of the present disclosure, the connection strength between the inner tube and the tire casing of the vehicle wheel is good, which can avoid the problem of the inner tube being loosened or separated from the tire casing of the vehicle wheel during use and improve the stability of the vehicle wheel operation.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions thereof are relatively specific and detailed, but they should not be construed as limiting the scope of the present disclosure. It should be noted that, for those of ordinary skill in the art, various variants and improvements can be made without departing from the concept of the present disclosure, and are all fallen within the protection scope of the present disclosure. Therefore, the patent protection of the present disclosure shall be defined by the appended claims.

What is claimed is:

1. A method for manufacturing a vehicle wheel, comprising:
forming a tire casing by curing and molding a first material, wherein the tire casing has a receiving groove;
forming an inner tube by centrifugally injecting a second material into the receiving groove and curing and molding the second material; and
removing the tire casing and the inner tube as a whole;
wherein at least during a process of forming the inner tube by curing, negative-pressure air exhaust is performed.

2. The method according to claim 1, wherein forming the tire casing by curing and molding the first material comprises:
providing a first mould, wherein the first mould is provided with a first injection cavity and a first injection hole in communication with the first injection cavity;
centrifugally injecting the first material into the first mould through the first injection hole, and enabling the first material to evenly cover an inner wall of the first mould; and
obtaining the tire casing by cooling and curing the first material, wherein the tire casing is retained in the first mould.

3. The method according to claim 2, wherein forming the inner tube by curing comprises:
centrifugally injecting the second material into the first mould through the first injection hole, and filling the receiving groove of the tire casing with the second material; and
obtaining the inner tube by foaming and curing the second material, wherein the inner tube and the tire casing are connected as a whole.

4. The method according to claim 2, wherein in the first mould, a portion of a cavity wall of the first injection cavity covered by the first material serves as a first cavity wall, another portion of the cavity wall of the first injection cavity not covered by the first material serves as a second cavity wall,
the first injection hole extends through the second cavity wall and is in communication with the first injection cavity; the first mould is provided with a first exhaust hole configured to perform negative-pressure air exhaust; and the first exhaust hole extends through the second cavity wall and is in communication with the first injection cavity.

5. The method according to claim 2, wherein the negative-pressure air exhaust is performed during a process of centrifugally injecting the first material into the first mould and cooling and curing the first material.

6. The method according to claim 1, wherein a density of the tire casing is in a range of 0.6 g/cm³ to 0.8 g/cm³, and a density of the inner tube is in a range of 0.2 g/cm³ to 0.6 g/cm³.

7. The method according to claim 2, wherein the first material comprises polyurethane, the second material comprises polyurethane, and a density of the tire casing is greater than a density of the inner tube.

8. The method according to claim 1, wherein forming the tire casing by curing and molding the first material comprises:
providing a tire casing mould;
injecting the first material into the tire casing mould by an injection molding machine;
obtaining the tire casing by cooling and curing the first material; and
removing the tire casing from the tire casing mould.

9. The method according to claim 8, wherein forming the inner tube by curing comprises:
providing a second mould, wherein the second mould is provided with a second injection cavity and a second injection hole in communication with the second injection cavity;
placing the tire casing in the second injection cavity, and attaching the tire casing to a cavity wall of the second injection cavity;
centrifugally injecting the second material into the second injection cavity through the second injection hole, and filling the receiving groove with the second material; and
obtaining the inner tube by foaming and curing the second material, wherein the inner tube and the tire casing are connected as a whole.

10. The method according to claim 9, wherein in the second mould, a portion of the cavity wall of the second injection cavity that is in contact with the tire casing serves as a first cavity wall, another portion of the cavity wall of the second injection cavity that is not in contact with the tire casing serves as a second cavity wall,
the second injection hole extends through the second cavity wall and is in communication with the second injection cavity,
the second mould is provided with a second exhaust hole configured to perform negative-pressure air exhaust; and the second exhaust hole extends through the second cavity wall and is in communication with the second injection cavity.

11. The method according to claim 8, wherein the first material comprises thermoplastic polyurethane, and the second material comprises polyurethane.

12. The method according to claim 1, further comprising:
sleeving the tire casing and the inner tube as a whole on a hub.

13. A vehicle wheel, comprising:
a tire casing made of a first material, the tire casing having a receiving groove, and an inner wall of the receiving groove being arc-shaped;
an inner tube made of a second material, and the inner tube comprising a main body received in the receiving groove and a protrusion protruding from the receiving groove,
wherein the main body has an outer annular surface that is arc-shaped, and the outer annular surface is attached to the inner wall of the receiving groove.

14. The vehicle wheel according to claim 13, further comprising a hub provided with an annular mounting groove; wherein the inner tube and the tire casing are connected as a whole and are sleeved on the hub, and the protrusion of the inner tube is engaged in the mounting groove.

15. The vehicle wheel according to claim 14, wherein a first step surface is formed on a side of the main body connected to the protrusion, and an end of a groove wall of the mounting groove abuts against the first step surface.

16. The vehicle wheel according to claim 13, wherein a density of the tire casing is in a range of 0.6 g/cm³ to 0.8 g/cm³, and a density of the inner tube is in a range of 0.2 g/cm³ to 0.6 g/cm³.

17. The vehicle wheel according to claim 13, wherein the first material comprises polyurethane, the second material comprises polyurethane; and a density of the tire casing is greater than a density of the inner tube.

18. A vehicle wheel, comprising:
a hub having an annular shape, the hub being provided with a mounting groove extending in a circumferential direction thereof;
an inner tube sleeved on the hub and at least partially received in the mounting groove; and
a tire casing covering the inner tube, and an inner surface of the tire casing being in close contact with the inner tube;
wherein one of an outer surface of the tire casing and the hub is provided with a first concave portion, and another one of the outer surface of the tire casing and the hub is provided with a first convex portion engaged with the first concave portion;
wherein one of the inner surface of the tire casing and the inner tube is provided with a second convex portion, another one of the inner surface of the tire casing and the inner tube is provided with a second concave portion, the second convex portion and the second concave portion are engaged with each other and located in the mounting groove.

19. The vehicle wheel according to claim 18, wherein the tire casing comprises a first ring portion and two second ring portions disposed at two ends of the first ring portion, the first ring portion being located outside the mounting groove; outer surfaces of the two second ring portions respectively press against a sidewall of the mounting groove; the second convex portion is disposed on each of inner surfaces of the two second ring portions, and the second concave portion is disposed on the inner tube.

20. The vehicle wheel according to claim 18, wherein at least a portion of the inner tube extends out of the tire casing and forms an inner annular surface, and the inner annular surface presses against a bottom wall of the mounting groove.
